(19) United States
(12) Patent Application Publication
(10) Pub. No.: US 2005/0233032 A1
(43) Pub. Date: Oct. 20, 2005

(54) Mixed starter culture and uses thereof

(75) Inventors: Tony Savard, Quebec (CA); Claude P. Champagne, Quebec (CA); Helene Gaudreau, Quebec (CA)

Correspondence Address: OGILVY RENAULT LLP, 1981 MCGILL COLLEGE AVENUE, SUITE 1600, MONTREAL, QC, H3A2Y3, CA

(73) Assignee: SA MAJESTE LA REINE DU CHEF DU CANADA, Saint-Hyacinthe (CA)

(21) Appl. No.: 10/503,584

(22) PCT Filed: Feb. 13, 2003
(86) PCT No.: PCT/CA03/00200

§ 371 Date: Jun. 3, 2005

Related U.S. Application Data
(60) Provisional application No. 60/356,153, filed on Feb. 14, 2002.

(51) Int. Cl. A23L 1/28

(52) U.S. Cl. 426/62

(57) ABSTRACT

The present invention relates to composition and mixed culture used for inhibiting the growth or killing spoilage or pathogenic microorganisms that can be found in different fermented foods, such as vegetables. The composition comprises at least one fermentation microorganism and at least one killer yeast producing an agent that inhibit the growth or kill other spoilage or pathogen microorganisms. Killer yeasts can be added before, during or fermentation processing of foods.

### TECHNICAL FIELD

The present invention relates to methods and starter culture medium and microorganisms for inhibiting the spoilage and pathogen microorganisms in fermented foods. The method and composition of the present invention is generally used to control the growth of food spoilage and/or foodborne pathogenic microorganisms in raw food substances and finished food products after processing. Selected yeasts, blended with the lactic acid microorganisms, are capable of producing yeast killer agents, conferring longer storage stability to processed or treated foods.

### BACKGROUND OF THE INVENTION

A variety of food products are available worldwide which depend on active bacterial cultures in the final form of the food product for flavor, preservation of quality, claimed health benefits and/or pH. Examples are fermented vegetable products, such as sauerkraut from cabbage and pickles from cucumbers; fermented fish products such as fish paste or burongdalog; fermented seeds such as coffee or cocoa beans; fermented starch-rich food products; fermented meat products; fermented cassava; fermented milks such as cheese or yogurt, or fermented fruit juices.

The presence of food spoilage organisms and pathogens in foods is a major concern to the food processing industry, government regulatory agencies and food consumers. Foodborne pathogens have been responsible for several food poisoning outbreaks, some of which have resulted in serious illness and death. In addition, the presence of pathogenic organisms in foods has led to numerous product recalls, product losses, and considerable negative publicity to the food industry. For example, a report of a case of listeriosis associated with the consumption of turkey franks provided direct evidence of the infection by Listeria monocytogenes linked to poultry products (Barnes et al., Morbid. Mortal. Weekly Rep. 38:267-268 (1989)). It has also been shown that L. monocytogenes occurs commonly in seafood, poultry, and meats including cured and fermented meats.

In food fermentation, bacteriocin-producing lactic acid bacteria have been used as fermentation starter cultures for fermenting meat and milk only. The preservation of the cured, dried, fermented sausage from spoilage and pathogenic microorganisms was due to a number of factors, including low water activity, sodium chloride, sodium nitrite, and low pH due to the production of organic acids by the starter culture organisms. However, while growth may be suppressed during fermentation and the drying process, these organisms may survive in the finished product.

Certain foods are perishable materials which are susceptible fungal, including yeast and mold, growth. Mold, yeast, or fungal growth in such foods can drastically reduces the usable life span of the foods. For example, dairy products, particularly cheese, and meat products, particularly fermented meat products such as sausages and pepperoni, are especially susceptible to being rendered unfit to eat by the growth of molds, and yeast.

Anti-mycotic materials are materials that inhibit mold, and yeast growth. Anti-mycotic materials are also commonly added to perishable foods susceptible to fungal growth to inhibit the growth of such materials in the food and extend the shelf life of the foods.

Anti-mycotic materials, which are added to foods to extend the usable life span of the foods, act by either an indirect or a direct mechanism to inhibit the growth of molds and yeasts. Indirect action anti-mycotics are materials such as enzyme/carbohydrate mixtures which react in combination with oxygen in a sealed package of food to scavenge and deplete oxygen in the package containing the anti-mycotic mixture, thereby inhibiting the growth of oxygen dependent fungi. Direct action anti-mycotics are materials applied in or on a food which inhibit the growth of a fungus upon direct contact with the fungus, often by inhibiting the development of fungus cell membranes. Direct action anti-mycotic materials are often preferable to indirect action anti-mycotics since indirect action anti-mycotics are only effective while a food material remains sealed in a package, and do not provide continuing anti-mycotic protection after the package of food is opened.

Since the discovery of killer activity in Saccharomyces cerevisiae, the killer yeast phenomenon has been explored. The killer character is known to be distributed in nature, having been detected in about 30% of the isolated yeast strains. It is known that killer yeasts may act by secreting a proteinaceous factor into the medium to which the killers themselves are immune. To date, killer yeasts have been reported in strains of several yeast genera including Saccharomyces, Candida, Cryptococcus, Debaryomyces, Hansenula, Kluyveromyces, Pichia, Torulopsis, Ustilago, Rhodotorula and Trichosporon, Hanseniaspora, Williopsis and Zygowilliopsis, and Zygosaccharomyces and have been classified in a spectrum of 11 activities (K1 to K11).

Killer yeasts have found several applications. They have been used as a model for the mechanisms of regulation of eukaryotic polypeptide processing, secretion and receptor binding (Sossin et al., 1989, Neuron, 2:1407-1417) and in recombinant DNA technology (Dignard et al., 1991, Mol. Gen. Genet. 227.:127-136). In the food and fermentation industries, killer yeasts or only the killer characteristics have been used in order to counter wild types, contaminating yeasts during the production of beer, wine and bread.

To date, killer yeasts have never been used in the production of fermented vegetables. The industrial lactic fermentation of vegetables, such as sauerkraut production, is generally carried out by a spontaneous fermentation and is the result of the growth of lactic acid bacteria. In this process, yeasts generally do not contribute to the primary acid fermentation, but do appear during storage to carry out a secondary fermentation when the product is not pasteurized and if there are residual sugars following the lactic acid fermentation. During this period, some flavors could be modified but the main undesirable effect of this secondary fermentation is the production of CO₂ by yeasts, which can cause post-packaging problems or bloater damage in cucumbers.

It would be highly desirable to be provided with a composition and means of inhibiting growth of food spoilage and foodborne pathogen organisms in fully processed, and/or fermented or cured foods.

### SUMMARY OF THE INVENTION

One object of the present invention is to provide a vegetable processing composition for killing or inhibiting growth of spoilage or pathogenic microorganism of vegetables after processing comprising at least one fermentation microorganism and at least one killer yeast producing anti-spoilage or anti-pathogenic factor in a concentration effective for killing or inhibiting the growth of the spoilage or pathogenic microorganism during and after the processing.

The processing may be a fermentation, including organic acid or alcohol fermentation.

The fermentation can be performed by a yeast or a bacteria, and killer yeast can be selected from the group consisting of Saccharomyces, Candida, Pichia, Kluyveromuyces, and Williopsis.

The killer yeast may also be selected from the group consisting of Saccharomyces cerevisiae, Saccharomyces diastaticus, Candida glabrata, Pichia anomala (Hansenula), Hansenula anomala, Kluyveromyces marxianus, Pichia membranaefaciens, Willipsis saturnus var. mrakii, and Kluyveromuyces lactis.

Another object of the present invention is to provide a mixed culture comprising at least one organic fermentation microorganism and a killer yeast in a concentration effective for inhibiting the growth or killing food spoilage or pathogenic microorganisms in a food mixture during or after processing of the food mixture. The processing is preferably fermenting the food.

The food mixture will preferably consist in vegetables, but can be any other type of food that can be processed by fermentation, acid treatment, or the like.

The fermentation microorganism used in the present invention can be a bacteria or a yeast.

In accordance with the present invention there is provided a method for killing or inhibiting the growth of a spoilage or pathogenic microorganism in a food mixture, comprising combining at least one fermentation microorganism with a food substance fermentable by a fermentation microorganism, and a killer yeast to produce food mixture in which the killer yeast produces a growth inhibitor or killer molecule in concentration effective for killing or inhibiting growth of spoilage or pathogen microorganisms in said food mixture.

Another object of the present invention is to provide a system in which an organism capable of producing anti-microbial agent will kill or inhibit the growth of pathogens and spoilage organisms in foods by producing anti-microbial agent.

Another object is to provide a non-destructive method of inhibiting the growth of pathogens and spoilage organisms in foods using living cells of killer yeast wherein the organoleptic properties of the food are not changed as a result of cell growth and/or fermentation by the anti-microbial agent-producing organism.

A further object is to provide a method in which living cells of killer yeasts are combined with a food substance to inhibit the growth of pathogens and spoilage organisms by providing inhibiting amounts of anti-microbial agent.

### BRIEF DESCRIPTION OF THE DRAWINGS

FIG. 1 illustrates the growth of Kluyveromyces lactis ATCC 36906 at pH 6.0 (O) or at pH 3.5 (?),

FIG. 2 illustrates the growth of Pichia anomala ATCC 36903 (K5R5) in a vegetable juice medium (VJM) at 20° C. with different salt concentrations;

FIG. 3 illustrates net killer activity (Inhibitory zone minus hole diameter) of K5R5 (A) and K9R9 (B) crude toxins preparation on the target yeast Saccharomyces unisporus; and

FIG. 4 illustrates net killer activity (Inhibitory zone minus whole diameter) of K5R5 (A) and K9R9 (B) crude toxins preparation on the target yeast Saccharomyces bayanus.

### DETAILED DESCRIPTION OF THE PREFERRED EMBODIMENT

The present invention now will be described more fully hereinafter with reference to the accompanying drawings, in which preferred embodiments of the invention are shown. This invention, may, however, be embodied in many different forms and should not be construed as limited to the embodiments set forth herein; rather, these embodiments are provided so that this disclosure will be thorough and complete, and will fully convey the scope of the invention to those skilled in the art.

In accordance with the present invention, there is provided a composition, a starter culture and a methods for use for inhibiting the growth of or killing spoilage or pathogen microorganisms in processed or processing food.

According to one embodiment of the present invention, the processing of the food is preferably fermentation, such as, but not limited to, lactic acid fermentation. The invention can be exploited in processes of alcoholic or acid fermentation or processing. The processed food in which spoilage or pathogen microorganisms are killed or inhibited can be vegetables, meat or any other food that is processed through fermentation.

The present invention describes a process using killer yeast combined to a specific starter BLAC, that could be added to fermented vegetables so as to help prevent yeast-related spoilage during their storage. The process is based on the ability of the killer yeasts 1) to produce killer factors in a vegetable-based medium, 2) to inhibit the growth of spoilage yeasts, and 3) to not themselves become spoilage agents of the fermented products.

In one embodiment of the invention, different killer yeasts can be used in the realization of the invention, but preferably make use of 11 ATCC strains, such as Saccharomyces cerevisiae (ATCC 60731), Saccharomyces diastaticus (ATCC 36902), Saccharomyces cerevisiae (ATCC 36899), Candida glabrata (ATCC 36909), Pichia anomala (ATCC 36903), Kluyveromyces marxianus (ATCC 36907), Pichia membranaefaciens (ATCC 36908), Pichia anomala (ATCC 36904), Willioposis saturnus var. mrakii (ATCC 10743), Kluyveromyces lactis (ATCC 36906) and Candida glabrata (ATCC 15126).

Another embodiment of the present invention is a composition and method comprising [symbol] lactic-killer yeast [symbol] starter in fermented vegetables. Since a concern is the ability of the killer yeast to grow and produce sufficient killer factors during the rather short lactic fermentation period, relative adaptations are based on the inoculation level of yeasts required for the expression of the inhibitory conditions for the spoilage or pathogenic microorganisms. Sensory properties of the resulting fermented food and vegetables are also controlled and preserved.

This invention is based upon the discovery that some species of killer yeasts are capable of producing killer factors in an amount effective to inhibit the growth or killing foodborne pathogens and food spoilage organisms, even if the lactic acid bacteria are maintained under conditions that inhibit their cell growth and fermentation of carbohydrates and/or other substances to lactic acid and/or other organic acids. The invention provides a method of inhibiting the growth of food spoilage and/or foodborne pathogenic organisms in edible food substances by combining the food substance with living cells of lactic acid bacteria and yeasts capable of producing substances known as killer factors. Inhibitory amounts of killer factors are produced in the resulting food mixture under conditions in which the killer yeast population in the food mixture is not significantly growing and/or fermenting, or producing detectable flavor, aroma, textural or other organoleptic changes in the food substance.

As used herein, the term “fermentation” means lactic acid fermentation, that is, the anaerobic, enzymatic decomposition of carbohydrates to form considerable amounts of lactic acid and/or other organic acids.

The term “killer factor” means a protein substance produced by killer yeast that kills or inhibits closely different spoilage or pathogenic strains of yeasts. The term killer factor may also include the term killer toxin.

The term “food mixture,” as used herein means the killer yeast in combination with the edible food substance and fermentation microorganisms.

In one embodiment of the present invention, the fermentation microorganism can be bacteria as well as yeast or a mold.

Any organism which is capable of producing killer factors in the desired microbial-inhibiting amounts under conditions of limited-growth and fermentation, some species of which are widely used as starter cultures, have been shown to produce killer factors that are inhibitory to other saccharomyces for exemple.

By “effective amount” or “concentration” it is meant that the numbers or cell count of the food spoilage organisms or pathogens is decreased or does not increase under action of a inhibitory or killing factor as defined herein.

According to the invention, preferred killer factor-producing killer yeast are Hansenula anomala, and Pichia species, more preferably Pichia anomala (ATCC 36903).

According to the invention, it is preferred that any increase in cell count of the fermentation microorganism and killer yeast in the food mixture, or any fermentation of the food substance by the fermentation microorganism and killer yeast, does not significantly alter the pH or the organoleptic characteristics such as flavor, aroma, color, or texture of the food substance.

In addition, the food mixture may be stored or maintained at refrigeration temperatures to inhibit fermentation by the fermentation microorganism and killer yeast. Also, fermentation by the fermentation microorganisms may be inhibited by combining the food substance and killer yeast with substances such as sodium chloride, flavorings, antioxidants, antimicrobials, homectants, emulsifiers, stabilizers, and the like, to inhibit fermentation by the fermentation microorganism.

The killer yeasts, one strain or several, may be added to any food substance in which inhibition of growth of food spoilage and/or foodborne pathogens is desired, including raw foods and foods which are fully processed, cured or fermented prior to the addition of the inoculate. For example, killer yeasts may be added to unprocessed edible food substances including raw vegetables such as lettuce, cabbage or carrots or sauerkraut; or a cured processed food substance. Killer yeast may be added to the food substance by any suitable method, as for example, by blending or mixing, by spraying or misting a suspension of the yeast and a suitable carrier onto the surface of the food, and the like. For example, the killer factor-producing yeast culture could be incorporated into vegetables prior to further processing, such as fermenting, stuffing and/or cooking. Raw whole vegetables may be sprayed with or dipped into the killer yeast and fermentation microorganism culture, and chopped vegetables may be sprayed with, dipped into and/or mixed with the culture.

Food mixtures stored at refrigeration temperatures, or about 1 to 7° C., may be maintained under aerobic or anaerobic conditions, and may include a food substance containing a nutrient, carbohydrate and/or other substance that is fermentable by the fermentation microorganism fraction of the food mixture. The killer yeast may be either fermentative or non-fermentative with respect to a nutrient, carbohydrate and/or other substance contained in the food substance of the food mixture.

The invention further provides a food mixture that includes a population of living cells of a killer factor-producing lactic acid bacteria in combination with an edible food substance. The food substance may be any edible vegetable substance, including a raw food substance and fermentation microorganisms, or one which is fully processed, cured or fermented prior to the addition of the killer yeast population.

The food mixture contains the killer yeast in a cell concentration effective to provide a sufficient amount of killer factor to inhibit the growth of food spoilage and/or pathogenic organisms. The killer factor may be provided without significant increase in cell count and/or without significant fermentation by the fermentation microorganism or killer yeast population in the food mixture, of a nutrient, carbohydrate and/or other substance contained in the food substance and required for fermentation by the fermentation microorganisms or killer yeast. Any increase in cell count or fermentation by the killer yeast in the food mixture does not significantly alter the organoleptic properties of the food substance and/or the pH of the food mixture.

To inhibit fermentation of the food substance by the fermentation microorganisms or killer yeast fraction, it is preferred that (a) the food substance does not contain a significant amount of a nutrient, carbohydrate, and/or other substance which is required for fermentation by the fermentation microorganisms or killer yeast fraction, and/or (b) the fermentation microorganisms or killer yeast fraction is non-fermentative with regard to a nutrient, carbohydrate, and/or other substance contained in the food substance and required by the fermentation microorganisms or killer yeast for fermentation. In addition, the food mixture may be stored or maintained at refrigeration temperatures to inhibit fermentation by the fermentation microorganisms or killer yeast. Also, the food mixture may contain a substance which inhibits fermentation by the fermentation microorganisms or killer yeast, as for example, sodium chloride, flavorings, antioxidants, antimicrobials, humectants, emulsifiers, stabilizers, spices, acids, and the like.

An advantage of the present invention is the inhibition of foodborne pathogens and/or food spoilage organisms in raw, or processed or fermented meat and vegetable products through the production of killer factors in situ in the food mixture, rather than by the production of acids. Another advantage of the present invention over existing methods of inhibiting foodborne pathogens is the non-destructive means for controlling pathogenic organisms in vegetable products. The invention further provides for optimization of conditions for killer factors production and activity under conditions of non-fermentation and non-growth of the killer yeast fraction of the food mixture. Additionally, the invention incorporates living yet non-growing and non-fermenting the fermentation microorganisms or killer yeast into vegetable products which can produce growth inhibiting amounts of killer factors without the production of acids, and without changes in pH or organoleptic properties of the food substance.

The invention will be described with reference to various specific and preferred embodiments and techniques. However, it should be understood that many variations and modifications might be made while remaining within the spirit and scope of the invention.

The present invention will be more readily understood by referring to the following examples that are given to illustrate the invention rather than to limit its scope.

### EXAMPLE I

### Interaction Between Killer Yeast and Spoilage Yeast Responsible for Secondary Fermentation in Fermented Vegetables

Materials and Methods

Killer and Target Yeast Strains

Killer yeasts used in this study are listed in Table 1 and were obtained from the American type culture collection (ATCC) in lyophilized form. Strains were rehydrated in diluted Yeast and Mold broth (YM also known as Yeast extract and Malt extract) 1/10 (Difco laboratories, Detroit, Mich. U.S.A.) for ten minutes at 23° C. and were then transferred to pure YM broth and incubated at optimal growth temperature (Table 1) for 72 h. Cultures were streaked on acidified YM agar with 5N HCl (pH 4.0) and maintained on YM agar slants. Morphological examinations were performed on broth or agar cultures and gas production was determined in test tubes containing YM medium and Durham tubes.

TABLE 1
Examples of killer yeasts

| Type | | | |
|---|---|---|---|
| (□C) | ATCC | Name | Temperature |
| K1R1a | 60731 | Saccharomyces cerevisiae | 30 |
| K2R2 | 36902 | Saccharomyces diastaticus | 30 |
| K3R3 | 36899 | Saccharomyces cerevisiae | 30 |
| K4R4 | 36909 | Candida glabrata | 26 |
| K5R5 | 36903 | Pichia anomala (Hansenula) | 26 |
| K6R6 | 36907 | Kluyveromyces marxianus | 40 |
| K7R7 | 36908 | Pichia membranaefaciens | 26 |
| K8R8 | 36904 | Pichia anomala (Hansenula) | 26 |
| K9R9 | 10743 | Williopsis saturnus var. mrakii | 25 |
| K10R10 | 36906 | Kluyveromyces lactis | 26 |
| K11R11 | 15126 | Candida glabrata | 26 |

Two spoilage yeasts were isolated from Onion with Miso™ and Black radish™ products showing visible gas production during storage. The two strains were identified as Saccharomyces bayanus Y-43 and Saccharomyces unisporus Y-42 (FRDC culture collection, St-Hyacinthe, Canada). Identification was carried out using API 20 C. (Biomérieux, Montréal, Canada) and SIM procedures (Deak and Beuchat, 1996, Boca Raton, Fla., CRC Press).

Growth Kinetics of Killer Yeasts by Automated Spectrophotometry (AS)

For screening assays, growth kinetics of yeasts for abiotic factors pH and temperature were determined by automated spectrophotometry (AS) using with a Bioscreen™ apparatus (Labsystems, Helsinki, Finland). YM broth pH 6.0 or pH 3.5 (5N HCl) were inoculated at 0.1% with a standardized cell suspension having an optical density (OD) of 0.5 (corresponding to 1×1 CFU ml⁻¹), and 250 μl were added to the wells of the microplate. Incubation of the microplate was carried out at 26° C. for 48 h and OD at 600 nm was measured every 15 minutes. The microplates were shaken for 20 sec prior to and after to OD reading.

Sensitivity of Killer Yeasts to Organic Acids: Lactic and Acetic Acids

In the selection process of killer yeast to be added to the lactic starter, it was deemed that the yeast strain should be inhibited when maximal acid concentrations are produced by lactic acid bacteria to make sure that the killer yeast itself does not constitute a risk for secondary fermentation. To compare growth kinetics of killer yeasts in the presence of organic acids, the same AS procedure was used with YM pH 6.0 and pH 3.5, but 0.8% lactic and 0.4% acetic acid were added to the media. Lag time, μ max and OD max were compared for both pH media, with and without organic acids.

Killer Activity on Target Yeasts

Killer toxins were obtained from YM broth cultures propagated at 30° C. for 72 h in 15 ml test tubes, without agitation. Yeast cells were removed by centifugation at 4500 g (10 min/4° C.), and the cell-free supernatant (crude toxin) was recovered, filtered on 0.45 μm nitrocellulose membranes (Millipore, Milford, Mass., U.S.A.) and frozen at −20° C. until required.

The sensitivity of target yeasts was determined with Methylene Blue Agar (MBA) by the technique of Walker et al. (1995, FEMS Microbiol. Lett. 127:213-222). MBA was prepared in a citrate-phosphate buffer of pH 4.5 by the addition of 2% bacteriological agar (Difco Laboratories, Detroit, Mich. U.S.A.), 2% Sabouraud Liquid Medium (SLM, Oxoid, Hampshire, England) and 1% tryptone (BDH, Montreal, Canada), which were heated to 100° C. prior to the addition of 0.003% methylene blue (BDH) and 5% glycerol (Aldrich, Ontario, Canada) (Walker et al., 1995, FEMS Microbiol. Lett. 127:213-222). MBA was distributed in portions of 15 ml in test tubes then autoclaved at 121° C. for 15 min and cooled to 45° C. before addition of target yeasts to a final cell number of 1×10⁵ per Petri dish. Target cells were seeded into the molten MBA agar, mixed gently and then poured in Petri dishes. Killer activity of the eleven yeasts was evaluated by the inhibition of growth of the target yeasts on MBA agar. Positive results were revealed by clear zones surrounding the well in the agar. In some instances, the zone borders were characterized by blue-stained (dead) colonies (Walker et al., 1995, FEMS Microbiol. Lett., 127:213-222).

The crude toxin preparation of a given killer yeast was pipetted (100 μl) onto two sterile 12 mm diameter concentration disks (Bacto Disk, Difco Laboratories, Detroit, Mich., U.S.A.) separated by a single streak of the killer strain used to prepare the cell-free extract deposited on the disks; Target yeasts grew as a background lawn and inhibitory activity was evident as a zone of clearing surrounding the disk and/or the streak, which was marked by a stained blue, dead colonies if fungicidal activity was present. Plates were incubated at 30° C. for 72 h and were stored at 4° C. for two weeks to enhance the blue staining. Three independent trials were performed in duplicate and inhibition zones were measured (mm).

Effect of Growth Conditions on Killer Toxin Production

Since the optimal conditions for growth of killer yeasts are not necessarily the same as those for the production of toxins, the effect of growth parameters on killer toxin production were evaluated. The AS and MBA assays enabled the selection of two killer yeast effective against the spoilage yeasts, and further trials were carried out on media that simulated fermented vegetable products. The two preselected killer yeasts (K5R5 and K9R9; Table 1) were grown on vegetable juice media (VJM) prepared as described by Gardner et al. (2001). The effect of salt concentrations (2, 4, 6, 8 and 10%), pH of VJM (6.0, 5.0, 4.5, 4.0 and 3.5) and incubation temperatures (30, 20 and 7° C.) on killer factor production were evaluated. For assays on the effect of temperature, the VJM was adjusted to 2% salt and pH 4.5. For three assays on the effect of salt and pH, tubes were incubated at 20° C. Incubation times were variable, since the samples for killer activity were taken-5 h after the start of the stationary phase. This enabled sample collection when cultures had similar biomass levels and were at the same physiological state. An exception was made for samples incubated at 7° C. where incubation was stopped at 105 h. In order to verify reproducibility between assays, a control condition was prepared which was 2% salt, 20° C. and pH 4.5 standardized with 1N HCl.

Killer activity in the VJM was quantified with well diffusion plate assays (Young and Yagiu, 1978, Antonie Leeuwenhoek, 44:1-4), instead of using disks as described above. Target yeasts were seeded in molten MBA agar and crude yeast-fermented VJM was distributed as 50 μl aliquots into the wells (diameter, 8 mm). Plates were incubated at 20° C. for 72 h and inhibition zones were measured.

Results and Discussion

Sauerkraut products that are not pasteurized and have no preservatives, such as benzoic or sorbic acid, are at risk for yeast spoilage during storage. Thus, the overall aim of this study was to select killer yeasts that would be combined with a lactic starter to inoculate fresh vegetables and generate stable fermented vegetables.

Growth Kinetics of Killer Yeasts

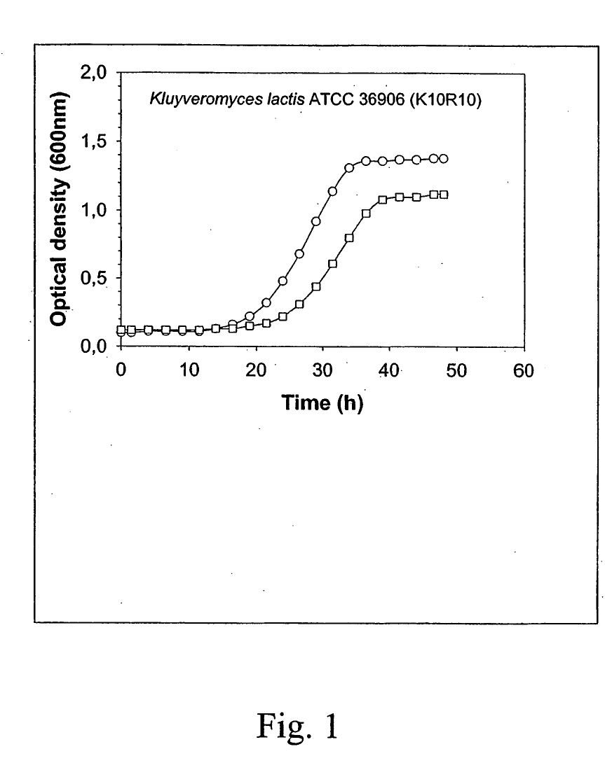

Killer yeasts tested in this study all significantly produced gas in YM medium. This pointed to the potential of unwanted gas production by the killer yeast. A typical growth curve of a killer yeast in YM broth at pH 6.0 and pH 3.5 is seen in FIG. 1. From such curves in VJM, μₘₐₓ, ODₘₐₓ and lag #me (time to obtain an increase of 0.1 in the OD of the medium) were determined (Table 2) pH 3.5 was chosen as the pH typically found in sauerkraut or other fermented vegetables. Acidification did not influence A values of most strains (Table 2). However, the ODₘₐₓ values were, on average, lower by 10% in the acidified media. Therefore, a pH of 3.5 in itself would not prevent growth of the killer yeasts during storage, and the combined effect of pH and organic acids was examined.

A heterolactic fermentation typically occurs during the fermentation of vegetables. In the products we have analyzed (Gardner et al., 2001), this results in the presence of 0.8% lactic acid and 0.4% acetic acid. Even at pH 6.0, the presence of the organic acids was inhibitory. Two strains had negligible growth, while others had, on the average, 26% lower μₘₐₓ values and 20% less biomass (Table 2). At pH 3.5, none of the strains grew in YM broth containing 0.8% lactic and 0.4% acetic acids.

Sensitivity of the killer yeasts to organic acids and pH was considered an important aspect for their incorporation into the lactic starter designed for fermented vegetables. It was deemed that killer yeast should grow in the initial stage of fermentation, and produce their killer factors during the first 48 h. Once the lactic fermentation is complete, it was considered undesirable that the killer yeasts demonstrate further growth in order to avoid spoilage of the fermented vegetables during storage. The results in the YM broths suggest that the killer yeasts would not be able to grow in the fermented vegetables due to the combined effect of pH and organic acids. The sensitivity of yeast to organic acids has been reported by Moon (1983) and results of this study adds to the literature in this respect. Inhibition was associated with the proportion of undissociated ions and is a function of the pH of the media and acid pKa. Lactate and acetate have a pKa of 3.86 and 4.75 respectively. In neutral media a greater proportion of ions are dissociated with rather little effect on the yeast growth (Table 2). Therefore, in acidified media (pH 3.5), ions are primarily in the undissociated form and have a major antimicrobial effect as we have observed in this study.

Effect of Killer Yeasts on Target Yeasts

Since it was determined that all killer yeasts were inhibited by the pH and organic acids encountered in the fermented vegetable products, they were all tested for their antimicrobial properties against the two spoilage yeasts. Results on MBA plates indicated that strains K5R5, K8R8, K9R9 and K10R10 have fungicidal effects (zones having blue-stained colonies on the borders) on S. unisporus Y-42, while strain K7R7 appears to only have a fungistatic effect (clear zone without blue-stained colonies on the borders) and other killer yeasts had no effect. On the target yeast, S. bayanus Y-43, killer activity was only associated with cultures of K5R5 and K9R9.

Production Parameters for the Killer Factors

Screening results on MBA agar suggested that strains producing the K5R5 and K9R9 killer factors were the most effective against the two spoilage yeast used as targets in the tests. Further studies on the selection of the killer yeast were then focused on the ability of these killer yeasts to produce their toxins in simulated conditions of vegetable fermentations. Parameters that can be modified in the production of fermented vegetables include the salt level as well as the incubation or storage temperatures. Since vegetable fermentation with lactic cultures is characterized by acidification, it was also deemed important to determine the effect of pH on the production of the killer factors.

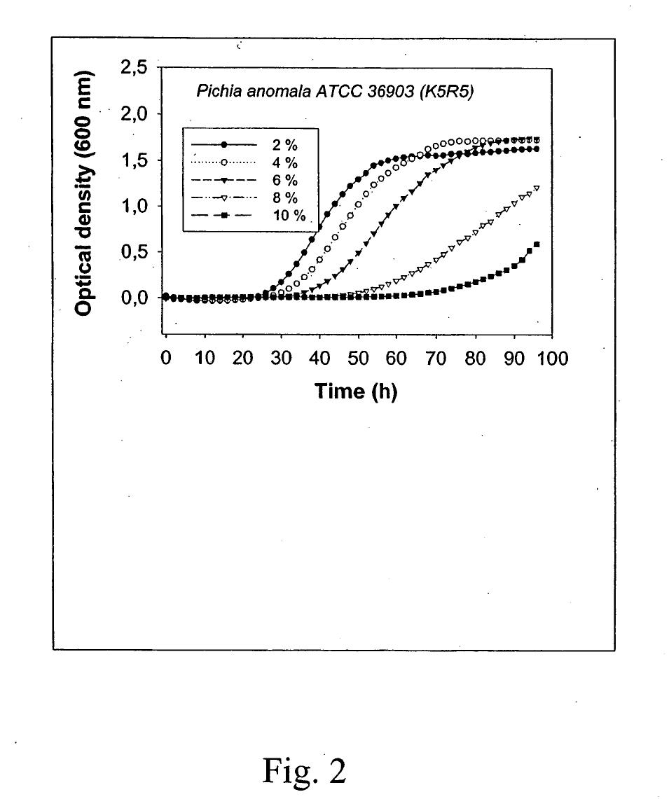

Since biomass level and physiological state influence the production of the killer factors (Young, 1987, Vol. 2, 2^{nd} ed., Academic Press, London, pp 134-164; Van Vuuren and Jacobs, 1992, Am. J. Enol. Vit. 43:119-128), it was our concern that the killer yeast cultures samples all be taken at the same biomass level and at the beginning of the stationary growth phase. This required preliminary assays to determine the time of sampling of the killer culture. The growth rate of the killer yeast in VJM was not highly affected by the pH of the medium (data not shown), which was in line with data on YM broths (Table 2). However, salt content strongly affected the growth rate of the killer yeasts, as is shown for strain K5R5 (FIG. 2) and the stationary growth phase was reached at different moments. Therefore, sampling times were modified accordingly (Table 3). As can be seen in FIG. 2, not all cultures had reached the stationary growth phase, but incubation was stopped at 105 h nevertheless. Thus, it must be kept in mind that cultures were not fully grown for samples that were taken at 105 h of incubation. The [symbol] well [symbol] method was used again for the determination of the killer effect on the target yeasts.

It was first determined if the growth media themselves were inhibitory to the target yeasts. None of the samples taken from the 13 unfermented VJM media produced inhibition zones on either of the target yeast. This was also the case for cultures exposed to their own fermented VJM. Thus ethanol in the yeast-fermented VJM media was not at an inhibitory level.

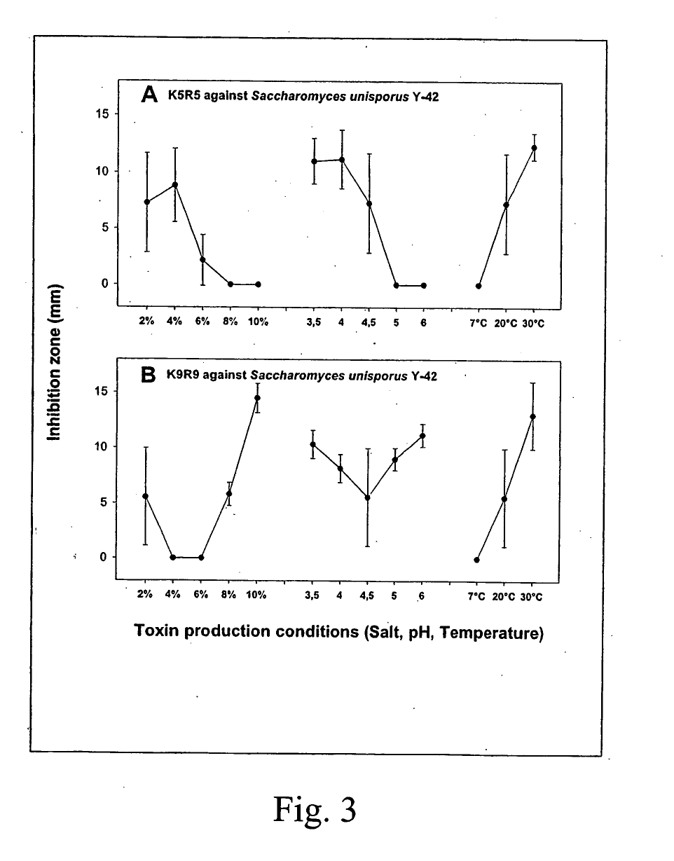

Inhibitory activity of K5R5 and K9R9 VJM-grown cultures on S. unisporus Y-42 is shown in FIG. 3. Production of killer factors is a function of salt concentration for both killer yeasts. Production of K5R5 toxins was higher at low salt concentrations with the optimum at 4% and decreased with increasing salt concentration; production was also promoted by low pH (FIG. 3A), and higher incubation temperature. The lower toxin production level for the K5R5 strain at salt concentrations greater than 4%, and at low incubation temperatures, might be related to the fact that the culture had not yet reached the stationary growth phase (Table 3), and would presumably have less biomass. The K9R9 strain showed a different production profile (FIG. 3B). Toxin production is also dependent on salt concentration and temperature, with the highest values at 10% and 30° C., respectively, but it is not significantly influenced by growth pH levels in the range tested (3.5-6.0).

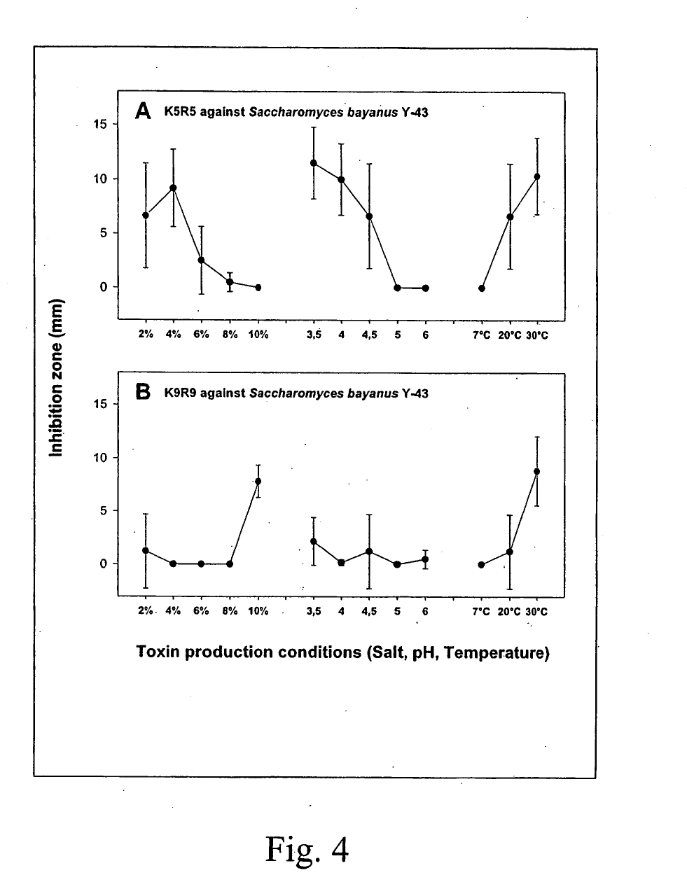

When we evaluated the production conditions on the second target yeast, S. bayanus Y-43, the same inhibitory profile was obtained but the intensity of activity varied with the target organism (FIG. 4). K5R5 inhibited both target yeasts with approximatively the same intensity while K9R9 was less effective against S. bayanus Y-43. The high inhibition of K9R9 samples in 10% salt suggests that production of the killer factors does not always appear to be coupled to extended growth.

Killer yeasts have been studied extensively. Optimal growth conditions and activity parameters for the toxin have been reported (Walker et al., 1997; FEMS Microbiol. Lett. 127:213-222) but the optimal conditions for toxin production are not well documented. However, it is generally recognized that killer factors are produced optimally by growing cells during the early phases of microbial growth. Nevertheless, optimal growth conditions could be different and may not be linked to optimal parameters for the toxin production. It can be recognized that killer activity varied with growth media independently of the biomass. This phenomenon was observed in our study with K9R9 and salt concentration where little growth at 6, 8 and 10% salt was associated with the greatest toxin production, suggesting that killer toxin production could be enhanced by adverse environmental conditions. There was no inhibition zone with media having up to 10% salt without the yeast, which shows that the salt content of the medium per se is not inhibitory. It remains to be determined, however, if the presence of high salt concentration in the medium could potentiate the effect of the killer toxins in reducing the growth rate of target yeasts.

TABLE 3
Incubation times required by Pichia anomala ATCC 36903 (K5R5)
and Williopsis saturnus var. mraki ATCC 10743 (K9R9) to reach
the stationary growth phase in a vegetable juice medium (VJM) having
different pH values, salt contents or at different incubation temperatures

| Fermentation condition | | |
|---|---|---|
| | Temperature | Time of sampling (h) |

| pH | Salt (%) | (° C.) | Strain K5R5 | Strain K9R9 |
|---|---|---|---|---|
| 3.5 | 2 | 20 | 90 | 96 |
| 4 | 2 | 20 | 90 | 82 |
| 4.5 | 2 | 20 | 82 | 82 |
| 5 | 2 | 20 | 74 | 76 |
| 6 | 2 | 20 | 68 | 98 |
| 4.5 | 2 | 20 | 82 | 82 |
| 4.5 | 4 | 20 | 86 | 102 |
| 4.5 | 6 | 20 | 102 | 105 |
| 4.5 | 8 | 20 | 105 | 105 |
| 4.5 | 10 | 20 | 105 | 105 |
| 4.5 | 2 | 7 | 105 | 105 |
| 4.5 | 2 | 20 | 82 | 82 |
| 4.5 | 2 | 30 | 57 | 62 |

These results suggest that, amongst the strains used in this study, the killer yeast Pichia anomala ATCC 36903 (K5R5) (Hansenula anomala) is the best choice for the preparation of a mixed lactic-yeast starter culture for use in vegetable fermentations. This species is a natural inhabitant of the vegetable microflora. Its seems compatible with lactic fermentation conditions of vegetables since good growth and activity in VJM was observed at 20° C., in the pH range of fermented vegetables and in 2% salt. Furthermore, K5R5 would not represent a spoilage threat since it is sensitive to the organic acid levels reached following the lactic fermentation.

When considering the inoculation of both lactic bacteria and killer yeasts to the vegetables, a question arises as to the ability of the killer yeasts to produce sufficient amounts of killer factors during the short lactic fermentation period and the LAB:yeast ratio to provide an appropriate lactic fermentation. A previous study has shown that the lactic fermentation is basically completed after 72 hours at 20° C. in the presence of 2% salt. Data from this study suggest that it would take strain K5R5 between 74 and 90 hours to reach the stationary growth phase under these conditions (Table 3). It remains to be seen if a sufficient quantity of inhibitory factors are produced under these conditions.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

1. A vegetable processing composition for inhibiting growth of or killing spoilage or pathogenic microorganisms contaminating said vegetables during or after processing comprising at least one fermentation microorganism and at least one killer yeast producing anti-spoilage or anti-pathogenic factor in a concentration effective for inhibiting the growth of or killing said spoilage or pathogenic microorganisms during and after said processing.

2. The vegetable processing composition of claim 1, wherein said processing is fermentation.

3. The vegetable processing composition of claim 2, wherein said fermentation is organic acid fermentation.

4. The vegetable processing composition of claim 2, wherein said fermentation is performed by a yeast or a bacteria.

5. The vegetable processing composition of claim 1, wherein said killer yeast is selected from the group consisting of Saccharomyces, Candida, Pichia, Kluyveromyces, and Williopsis.

6. The vegetable processing composition of claim 1, wherein said killer yeast is selected from the group consisting of Saccharomyces cerevisiae, Saccharomyces diastaticus, Candida glabrata, Pichia anomala (Hansenula), Hansenula anomala, Kluyveromyces marxianus, Pichia membranaefaciens, Willipsis saturnus var. mrakii, and Kluyveromuyces lactis.

7. A mixed culture comprising at least one organic fermentation microorganism and at least one killer yeast in a concentration effective for inhibiting the growth of or killing food spoilage or pathogenic microorganisms in a food mixture during or after processing of said food mixture.

8. The mixed culture of claim 7, wherein said food mixture consists in vegetables.

9. The mixed culture of claim 7, wherein said fermentation microorganism is a bacteria or a yeast.

10. The mixed culture of claim 7, wherein said fermentation is a lactic acid fermentation.

11. The mixed culture of claim 7, wherein said killer yeast is selected from the group consisting of Saccharomyces, Candida, Pichia, Kluyveromuyces, and Williopsis.

12. The mixed culture of claim 7, wherein said killer yeast is selected from the group consisting of Saccharomyces cerevisiae, Saccharomyces diastaticus, Candida glabrata, Pichia anomala (Hansenula), Hansenula anomala, Kluyveromyces marxinus, Pichia membranaefaciens, Willipsis saturnus vas. Mrakii, and Kluyveromyces lactis.

13. A method for inhibiting the growth of or killing a spoilage or pathogenic microorganism in a food mixture, comprising combining at least one fermentation microorganism with a food substance fermentable by a processing microorganism, and a killer yeast to produce food mixture in which said killer yeast produces a growth inhibitor or killer molecule in concentration effective for killing or inhibiting growth of spoilage or pathogen microorganisms in said food mixture.

14. The method of claim 13, wherein said processing microorganism is a bacteria or a yeast.

15. The method of claim 13, wherein said processing microorganism is a fermentation microorganism.

16. The method of claim 13, wherein said processing microorganism is selected from the group consisting of Saccharomyces, Candida, Pichia, Kluyveromyces, and Williopsis.

17. The method of claim 13, wherein said killer yeast is selected from the group consisting of Saccharomyces cerevisiae, Saccharomyces diastaticus, Candida glabrata, Pichia anomala (Hansenula), Hansenula anomala, Kluyveromyces marxinus, Pichia membranaefaciens, Willipsis saturnus vas. Mrakii, and Kluyveromuyces lactis.

18. The method of claim 13, wherein said food substance consists in vegetables.

19. The method of claim 13, wherein said food mixture is fermented.

20. The method of claim 19, wherein said food mixture is fermented by lactic acid fermentation.
